(19) United States
(12) Patent Application Publication
(10) Pub. No.: US 2019/0045756 A1
(43) Pub. Date: Feb. 14, 2019

(54) DARK-BRIGHT INTEGRATED GREENHOUSE SYSTEM IN INTENSIVE RECIRCULATING ECO-AQUACULTURE AND AQUACULTURE METHOD

(71) Applicant: HONGZE FISHSEEDS BIOTECHNOLOGY INC, LTD, Huaian (CN)

(72) Inventors: Qinghua Liu, Huaian (CN); Naomi Sudo, Tokyo (JP)

(21) Appl. No.: 16/165,998

(22) Filed: Oct. 19, 2018

(30) Foreign Application Priority Data
Oct. 9, 2018 (CN) 2018111717656
Oct. 9, 2018 (CN) 2018216318145

(51) Int. Cl. A01K 63/04; A01G 9/22; A01K 61/13; A01K 61/59; C02F 9/00

(52) U.S. Cl. CPC A01K 63/045; A01G 9/22; A01K 63/042; C02F 2103/20; A01K 63/047; A01K 61/59; C02F 9/00; A01K 61/13

(57) ABSTRACT

A dark-bright integrated greenhouse system in intensive recirculating eco-aquaculture and aquaculture method thereof. The greenhouse system comprises a bright area and a dark area: the bright area is mainly a water-quality biological purification area, and the dark area is mainly an aquaculture area. The aquaculture method of the present invention is an intensive recirculating eco-aquaculture method, which can improve and regulate the eco-aquaculture environments like illumination and temperature suitable for growth and development according to the requirement of aquaculture species on illumination.

### TECHNICAL FIELD

The present invention relates to the field of aquaculture technologies, and more particularly, to a dark-bright integrated greenhouse system in intensive recirculating eco-aquaculture and aquaculture method.

### BACKGROUND

At present, the main forms of greenhouse aquaculture include a film greenhouse and a frame greenhouse with relatively closed space, which intend to get rid of the traditional conditions that open-air aquaculture depends on whether, avoid the damages to aquaculture species caused by excessively high temperature of severe heat and excessively low temperature in cold winter as well as severe weather, and provide a more suitable and stable aquaculture environment for the aquaculture species. Most greenhouse aquaculture species are precious aquaculture species, such as prawns, shad, Coilia ectenes, groupers, and various freshwater shrimps and crabs.

Most greenhouse aquaculture models are open aquaculture modes or semi-open aquaculture modes. Due to the lack of special facilities for water treatment, water-quality and temperature are mainly regulated by periodically replacing a large amount of water. However, the discharge of aquaculture sewage not only wastes a large amount of water, but also causes a hazard to environmental resources. Scholars at home and abroad have developed a factory-based recirculating aquaculture system (RAS) and a greenhouse factory-based aquaculture system based on a RAS structure, but the aquaculture cost is relatively high, the threshold of the greenhouse aquaculture stays at a high level, most facilities are ineffective, and the systems are difficult to promote because the equipment is expensive, the operating cost is high, and the denitrification is imperfect, which causes nitrate accumulation and unstable pH as well as a number of water is needed to replace to maintain the normal operation of the systems. It is of a significant value to the sustainable development of the aquaculture industry in China to establish an intensive eco-aquaculture greenhouse mode which is environmentally friendly, low in cost, simple and feasible, and stable and reliable according to an imitative-ecological principle and an intensive aquaculture technology.

In fact, in the greenhouse aquaculture system, the aquaculture species and aquatic organisms require completely different ecological environments. Although illumination is one of the most important environmental factors affecting the growth and reproduction of the aquatic organisms, they have completely different requirements on illumination intensity and photoperiod. Submerged plants, algas, and photosynthetic bacteria require sufficient sunshine to meet their growth needs, but most aquatic animals are not suitable for living in a bright environment.

The latest researches show that the suitable illumination range for aquatic vascular plants is 4×103 to 6×104 1×, most submersed plants have a light compensation point of 26 to 137 1×, and can positively grow in a depth of 2 to 3 m, and the growth of the submerged plants can greatly improve the activity and diversity of rhizospheres and non-rhizosphere microorganisms in deposits, thereby indirectly improving the water-quality purification ability of the microorganisms; and the photosynthetic bacteria at the bottom layer of the water body include a photoautotrophic bacterium and a photoheterotrophic bacterium; in the case of light and deficiency of oxygen, it not only can degrade toxic and harmful inorganic and organic pollutants in aquaculture sewage, but also can promote the growth of beneficial algas such as diatom and green alga through improving the water-body environment, thereby breaking the situation that harmful cyanobacteria dominates the world, promoting the biodiversity development of water ecology, and comprehensively playing the role of water-quality purification. In short, the water-quality purification based on illumination can degrade harmful substances such as carbon dioxide, nitride, phosphide, sulfide and organic pollutant in water, can produce oxygen to increase dissolved oxygen in the water, and plays important and sustainable water-quality purification, and healthy and stable roles to the aquaculture water body.

However, most aquaculture animals prefer a darker environment. For example, in an aquaculture environment with strong illumination, most aquaculture species such as fishes, shrimps and crabs sneak into the bottom layer with weaker light to avoid illumination, and emerge out from a water surface or shore for ingestion in the early morning, evening or night when the light is weak. The effects of illumination intensity on the growth, development and survival rate of the aquatic animals vary from species to species. The latest researches show that Salmo salar belongs to pelagic fish and has the optimum growth rate under the illumination intensity of 200 to 600 1×, while the benthic Hippoglossus grows fast under the illumination intensity of 1 to 10 1×. Although the aquaculture species have significant species specificity for suitable illumination range, most precious aquaculture species are suitable for low light, and the illumination intensity greater than 1000 1× may inhibit or harm their growth.

In conclusion, the aquaculture species and the aquatic organisms not only have different requirements on temperature, but also have different requirements on illumination intensity and photoperiod. We have measured the illumination of a variety of greenhouses for many years, the water surface illumination intensity of an ordinary sunlight greenhouse usually ranges from 5×10³ to 2×10⁴ 1×. In summer, the illumination can reach 5×10⁴ 1× at noon, and even in shaded greenhouse, the illumination intensity is often as high as 8×10³ 1× or above. Obviously, the illumination intensity of the ordinary sunlight greenhouse far exceeds the requirement of most aquaculture species such as fishes, shrimps and crabs. Strong illumination is not conducive to the fishes, shrimps and crabs, which may cause direct ultraviolet radiation damage, or trigger the stress response of the aquaculture species to endanger their health. In the greenhouse aquaculture system, it is of great values to create a harmonious block-type small ecological environment suitable for the growth and development of various aquatic organisms in the aquaculture greenhouse according to the biological characteristics of the aquatic organisms and their specific requirements of growth and development on the illumination intensity to increase the ecological and production benefits of the aquaculture greenhouse, and has a broad development prospect.

### SUMMARY

Object of the present invention: in order to overcome the defects of low efficiency and low water-quality purification efficiency of aquaculture caused by the problem of “illumination homogenization of greenhouse aquaculture” in the prior art, the present invention conducts unique functional block-design to the aquaculture greenhouse according to the specific requirements of the aquatic organisms on the illumination intensity, the biology characteristics thereof and a water-quality purification principle for recirculating eco-aquaculture, which separates the aquaculture greenhouse into two functional areas, i.e., a well-lighted bright area and a dimly-lit dark area to form the dark-bright integrated greenhouse. In addition to the importance of temperature, the most important ecological condition in the bright area is sufficient illumination to meet the needs of aquatic-alga-bacterium photosynthesis symbioticsystem using light as energy for the water-quality biological purification. In the dark area, the most important ecological conditions are dissolved oxygen, water-quality and water flow to meet the growth and development needs of the aquaculture animals, and intensive illumination may have harmful effects. Therefore, a technical problem to be solved by the present invention is to provide a dark-bright integrated greenhouse system in intensive recirculating eco-aquaculture and a management method, which meet the requirements of the aquatic plants and the aquaculture animals respectively for different light intensities and maximize the production and ecological benefits of the intensive aquaculture greenhouse.

Another technical problem to be solved by the present invention is to provide an application of the greenhouse system in aquaculture.

The last technical problem to be solved by the present invention is to provide a intensive recirculating eco-aquaculture method.

Technical solutions: in order to solve the problems in the prior art, the present invention provides a dark-bright integrated greenhouse system in intensive recirculating eco-aquaculture, comprising a greenhouse, wherein the greenhouse comprises a pond and a sunlight board covering above the pond, the pond is separated into a bright area and a dark area by a first partition, a sun shield or a sun cloth is covered on the sunlight board right above the dark area, and the dark area is an aquaculture area provided with a probiotics application area and a plurality of aerators; the first partition is provided with a fixed block-net and a pump outlet, the pump outlet is connected with a pump, the pump is located in a pump cage, purified water of the bright area is pumped into the dark area by the pump, and the fixed block-net provides a channel for aquaculture sewage of the dark area to flow into the bright area, which constitutes one-way water circulation between the bright area and the dark area; the bright area is separated into a first water treatment area and a second water treatment area by a second partition, which extends a path for a water flow with purified water-quality; the first water treatment area is provided with a primary sedimentation purification area and a water-quality biological purification area, the second water treatment area is also provided with a water-quality biological purification area, and the water-quality biological purification area is provided with a submerged flora planting area and a photosynthetic bacterium application area.

The greenhouse of the present invention is a plastic film greenhouse or a color steel tile structure greenhouse, and a culture pond or a pond can be built in the greenhouse, which can be a cement pond or a soil pond. The greenhouse can be a series greenhouse or a parallel greenhouse, which is artificially separated into different aquaculture areas and can culture different varieties. A wall body of the first partition or the second partition is built with building materials or is formed by piling sandbags.

The present invention is divided into a bright area and a dark area, wherein the bright area is an illumination-based water-quality biological purification area, and the aquaculture sewage flows from the dark area, i.e., the aquaculture area, to the primary sedimentation purification area of the bright area through the fixed block-net, a sunlight board or plastic film with excellent transmission is adopted in a top layer of the bright area to provide sufficient light for the bright area, so that the illumination intensity of a water surface layer in the bright area is greater than 5000 1×. A partition wall of the bright area can be formed in the center of the bright area by brick walls or sandbags, to separate the bright area into several areas to extend a water flow path of the sewage in the water-quality biological purification and provide different water-purification ecological environments. The pump is a low-heading pump or a water-pushing aeration pump. A power of the pump depends on a size of a water body, and a daily water body exchange rate between the dark area and the bright area is 0.5 to 5 times. Purified water of the bright area is pumped into the aquaculture area of the dark area by the pump through a pump outlet to provide purified water with excellent water-quality for aquaculture species. Due to a pressure deficit, the aquaculture sewage automatically flows into the primary sedimentation purification area of the bright area through the fixed block-net of the wall body in the center for purification. The primary sedimentation purification area of the bright area has a deep water of 1.2 to 3.5 meters, and is planted with high-stem submerged floras such as reeds. The lush plants can slow down the flow rate and promote the sedimentation of the aquaculture sewage particles. The water-quality biological purification area is an aquatic-photosynthetic bacterium symbiotic system with a shallow water of 1.0 to 2.5 meters, planted with submerged floras such as Vallisneria natans, and regularly applied with photosynthetic bacteria that are sprayed 1 to 6 times in every month to promote the diversified balanced development of aquatic-photosynthetic bacterium and three-dimensional water-quality purification.

In the aquatic-photosynthetic bacterium symbiotic system, the aquatic plants are submerged floras comprising one or more of reeds, Vallisneria natans, Myriophyllum verticillatum, Ceratophyllum demersum, Potamogeton crispus and Hydrilla. The photosynthetic bacteria applied in the photosynthetic bacterium application area comprise a photoheterotrophic bacterium and a photoautotrophic bacterium.

The present invention further comprises an intensive recirculating eco-aquaculture method based on the system. The aquaculture method regulates different illumination intensities of the dark area using different shading methods and shading areas to meet different requirements and adaptabilities of different aquaculture species and different growth stages on dark light.

When the aquaculture specie is Alosa sapidissima, the illumination intensity is 100 to 400 1×, when the aquaculture specie is Perca flavescens, the illumination intensity is 50 to 150 1×, when the aquaculture specie is Siniperca chuatsi, the illumination intensity is 150 to 400 1×, when the aquaculture specie is Eriocheir sinensis, the illumination intensity is 50 to 100 1×, and when the aquaculture specie is Penaeus vannamei, the illumination intensity is 50 to 300 1×.

When culturing shad, Alosa sapidissima, ammonia nitrogen is 0.2 to 0.8 ppm, dissolved oxygen is no lower than 5 ppm, and a temperature is 16 to 28° C. when feeding Penaeus vannamei, a water temperature is 22 to 32° C., a pH value is 7.2 to 8.5, dissolved oxygen is more than 4 mg/L, ammoniacal nitrogen is less than 0.2 mg/L, and nitrite is less than 0.1 mg/L.

The aquaculture method according to the present invention is an intensive recirculating eco-aquaculture method which establishes an eco-aquaculture environment suitable for high-density aquaculture of the aquaculture species in the dark area. The dark area according to the present invention is an intensive culture pond, the top layer of which is covered by the sun cloth or sun shield to shield the sunshine and form the low-light area, i.e., the dark area. The present invention further comprises an intensive recirculating eco-aquaculture method based on the system. The aquaculture method regulates different illumination intensities of the dark area using different shading methods and shading areas to meet different adaptabilities and special requirements of the aquaculture species and different growth stages on illumination. In general, the illumination intensity of the water surface layer of the aquaculture area is controlled within a range between 20 and 1000 1×. The solar rays in summer have strong ultraviolet radiation effects, which are particularly harmful to larvae of the aquaculture species, or cause larger stress reaction to the larvae to make them get ill and die. Our researches show that when the illumination intensity on the water surface of the culture pond reaches 1500 1×, it constitutes a half lethal illumination intensity to the larvae of the shads. In fact, the aquaculture species have extremely different preferences for illumination: the suitable illumination intensity for the shad is 100 to 400 1×, the suitable illumination intensity for Perca flavescens is 50 to 150 1×, the suitable illumination intensity for Siniperca chuatsi is 150 to 400 1×, the suitable illumination intensity for the Eriocheir sinensis is 50 to 100 1×, and the suitable illumination intensity for the Penaeus vannamei is 50 to 300 1×.

In the intensive aquaculture area of the dark area, the water depth is 1.0 to 3.0 meters, and a peddle-wheel aerator or a nano-tube aerator is used for oxygen aeration, so as to meet the dissolved oxygen supply for the aquaculture species. Taking peddle-wheel aerator as an example, several peddle-wheel aerators are installed in the intensive aquaculture area according to the aquaculture density or organic load to increase oxygen and stir the water body and form a directional water flow in the aquaculture area. The water flow can not only help fishes, shrimps and crabs to acquire the dissolved oxygen, improve the vitality of the cultured animals and increase the fluidity of the water body, but also promote water body exchange, especially the water flowing in the bottom layer, and help to enhance the vitality of microbial flora. In the intensive aquaculture area, microecological preparations (probiotics) are regularly applied, for example, probiotics including Bacillus, nitrifying bacteria and lactic acid bacteria are sprayed 1 to 6 times in every month to establish a healthy and active microbial community with purified water-quality and improve the water-quality purification capacity of microorganisms in the water body. A deep well water outlet pipe is installed near the aerator. A water temperature of the deep well is 16 to 20° C. all the year round. The deep well water is regularly added in summer for cooling and regularly added in winter for warming up, so as to regulate and stabilize the water temperature. The related aquaculture species cultured in the aquaculture area comprise fishes, shrimps, crabs, or the like.

Beneficial effects: compared with the prior art, the present invention has the following advantages.

1) The design of the dark-bright integrated greenhouse rationally separates and logically integrates aquaculture production and water-quality purification, to strengthens different ecological requirements of the aquaculture production and the water-quality purification on the illumination intensity, and effectively overcomes the defects of “illumination homogenization” of the existing greenhouse aquaculture system. The dimly-lit dark area meets the ecological requirement of the aquaculture species liking a dark environment, and avoids the bloom of cyanobacteria caused by illumination in the greenhouse aquaculture, which occurs frequently but cannot be solved, as well as the damage of ultraviolet radiation on fishes, shrimps and crabs, and the stress reaction caused. The well-lighted bright area meets the requirement of a water-quality purification system for aquatic-photosynthetic bacterium symbiosis, and maximizes the production and ecological benefits of intensive greenhouse aquaculture; moreover, warm and suitable illumination control can significantly increase the growth rate and survival rate of the fishes, shrimps and crabs.

2). The separation of the bright and dark areas can meet the specific ecological requirements of plants and animals respectively on a water flow, and maximize the water treatment efficiency of plants and the production benefits of aquaculture species. Most aquatic animals have a common natural ecological habit, i.e., loving flowing water. In the dark area, the fluidity of the water body is increased through the aeration equipment, including the peddle-wheel aerator, while increasing the dissolved oxygen. The can not only help fishes, shrimps and crabs to acquire the dissolved oxygen, improve the vitality of the cultured animals and increase the fluidity of the water body, but also promote water body exchange, especially the water flowing in the bottom layer, and help to enhance the water-quality purification ability of the microorganisms like Bacillus. However, the aquatic plants, especially the submerged plants, are not suitable for survival in a rapid-flowing water environment, which may damage an aquatic vascular plant and cause lodging, thereby destroying the water-qualification purification system of the aquatic plants.

3) In the bright area with the water-quality purification function, the defects of incomplete water-quality purification, high cost, nitrate residue and great change of pH caused by the poor denitrification function in the current factory aquaculture system are overcame through the aquatic-photosynthetic bacterium symbiotic and complementary system, so that the dark-bright integrated greenhouse system becomes one of the aquaculture systems with the highest efficiency in aquaculture and water-quality purification. The system has the functions of primary sedimentation, nitrification and denitrification biological purification, biological aeration, etc., forming a complete water-quality purification system without nitrate nitrogen residue. In addition, the aquatic-photosynthetic bacterium symbiotic purification system effectively inhibits the growth of harmful microorganisms such as Cyanobacteria, Actinomycete and mould, and does not have any off-flavor. Therefore, the fishes, shrimps and crabs produced by the system have excellent quality and taste, and has better market value.

4) The photosynthesis of the aquatic plant is mainly in the middle and upper layers of the water body, while the microorganisms such as photosynthetic bacterium are in the anaerobic bottom layer of the water body, forming a three-dimensional and high-efficiency biological purification system: the purified water comprehensively processed through the photosynthesis and microorganism is pumped into the aquaculture area by a low-heading large-flow pump to provide a good water-quality environment for the aquaculture species, so as to realize zero discharge of the intensive recirculating eco-aquaculture in the true sense.

5) The system and the aquaculture method have high aquaculture efficiency, fast growth rate and high survival rate. Taking shad aquaculture as an example, most shads reach a market specification of 600 g in 10 months, with a survival rate of over 80%, while it takes 14 months for the shads cultured in the traditional greenhouse aquaculture to reach the market specification, and the survival rate of the traditional greenhouse aquaculture is about 40 to 60%.

6) The system has strong stability, and is suitable for the aquaculture of precious seawater and freshwater fishes, shrimps and crabs with harsh requirements on the ecological environments, and is widely used, low in cost, and simple and easy to operate, has stable and reliable water-quality without needing any drugs, and has the potential for sustainable development.

### BRIEF DESCRIPTION OF THE DRAWINGS

FIG. 1 is a schematic diagram illustrating an external structure of a dark-bright integrated greenhouse aquaculture system;

FIG. 2 is a structural schematic diagram of a dark-bright integrated greenhouse aquaculture system of the present invention; and

FIG. 3 is a structural schematic diagram of a pond portion of the present invention.

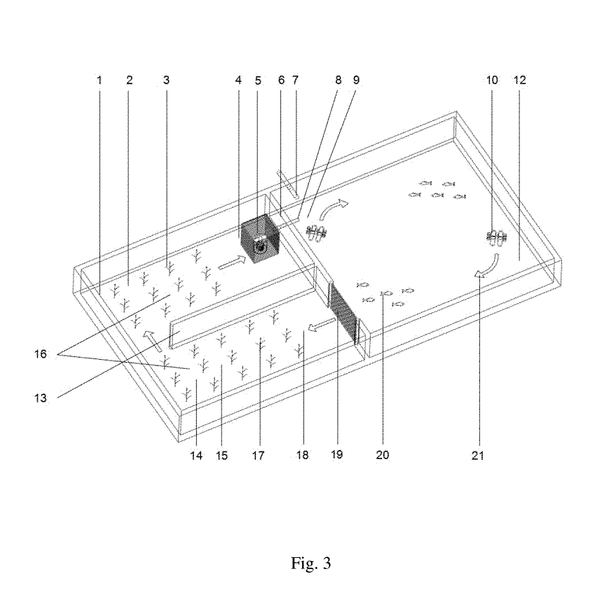

### DETAILED DESCRIPTION

### First Embodiment: Shad Culturing in Dark-Bright Integrated Greenhouse

Shad is a migratory fish, and is a stenothermal organism, which is suitable to grow in a temperature ranging from 18 to 28° C. Therefore, it is necessary to keep warm in winter and prevent sunstroke in summer. To ensure the survival rate, the shad must be cultured in the greenhouse, and also provided with good water-quality, water flow and adequate dissolved oxygen throughout the culturing.

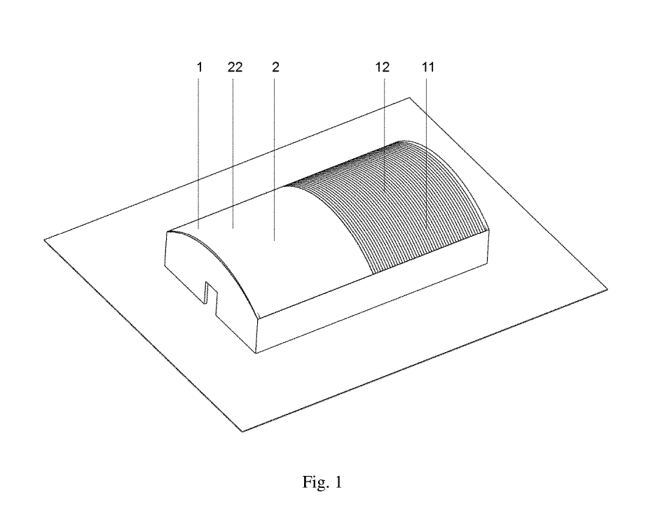

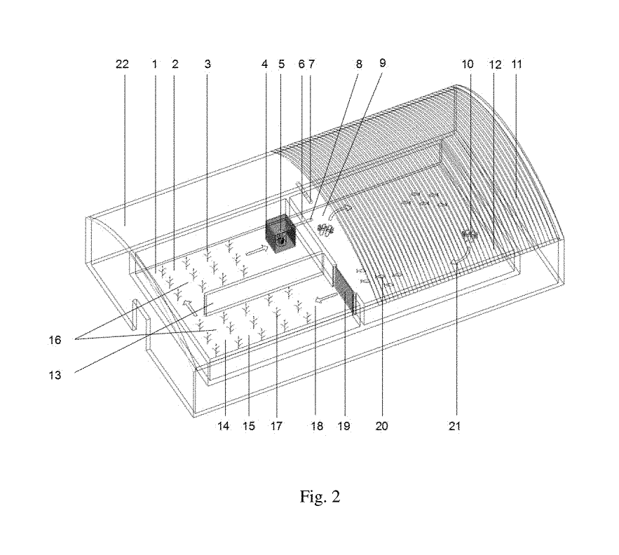

The dark-bright integrated greenhouse system in intensive recirculating eco-aquaculture is as shown in FIG. 1, wherein the greenhouse is a plastic film greenhouse or color steel tile structure greenhouse (as shown in FIG. 1 or FIG. 2). A culture pond or pond is built in the greenhouse, which may be a cement pond or a soil pond. The greenhouse comprises a pond 1 and a sunlight board 22 covering above the pond 1, the pond 1 is separated into a bright area 2 and a dark area 12 by a first partition 6, a sun shield or a sun cloth is covered on the sunlight board 22 right above the dark area 12, the first partition 6 is provided with a fixed block-net 19 and a pump outlet 8, the pump outlet 8 is connected with a pump 5, and the pump 5 is mounted in a pump cage 4. Purified water of the bright area is pumped into an aquaculture area 20 of the dark area 12 by the pump to provide purified water with excellent water-quality for the shad. Due to a pressure deficit, the aquaculture sewage automatically flows into a primary sedimentation purification area 18 and a water-quality biological purification area 16 through the fixed block-net 19 of a wall body in the center for purification, thus forming consistent water-quality exchange and recirculating. The bright area 2 is separated into a first water treatment area and a second water treatment area through a second partition 13. The first water treatment area is provided with the primary sedimentation purification area 18 and the water-quality biological purification area 16, submerged plants 17 are planted in the primary sedimentation purification area 18 to reduce a water flow speed and promote pollutional granules to settle by bushy plants.

The second water treatment area is also provided with the water-quality biological purification area 16. The water-quality biological purification area 16 is provided with a submerged flora planting area 3 and a photosynthetic bacterium application area 15.

The bright area 2 of the present invention is a water-quality biological purification area designed by an imitative-ecological principle. The bright area 2 is an aquatic-photosynthetic bacterium symbiosis system composed of aquatic plants mainly based on photosynthesis and photosynthetic bacteria living on light energy, forming a three-dimensional imitative-ecological water-quality biological purification system, which can effectively reduce cultivation pollution such as ammonia nitrogen and phosphide. The sewage flowing in from the dark area 12 (i.e., the aquaculture area) through the fixed block-net 19 is purified. A sunlight board or plastic film with better light transmission is adopted in the bright area 2, providing sufficient illumination for the bright area 2, so that the illumination intensity of a water surface layer of the bright area 2 is greater than 5000 1×. A partition wall of the bright area can be formed in the center of the bright area by brick walls or sandbags, to separate the bright area 2 into several areas to extend a water flow path for sewage purification and provide different water-purification ecological environments. The pump 5 is a low-heading pump or a water-pushing aeration pump. A power of the pump 5 depends on a size of a water body, and a daily water body exchange rate between the dark area 12 and the bright area 2 is 0.5 to 5 times. Purified water of the bright area 2 is pumped into the aquaculture area 20 of the dark area by the pump 5 through a pump outlet 8 to provide purified water with excellent water-quality for aquaculture species. Due to a negative pressure, the aquaculture sewage automatically flows into the primary sedimentation purification area 18 of the bright area through the fixed block-net of the wall body in the center for purification. The primary sedimentation area 18 of the bright area 2 has a water depth of 1.2 to 3.5 meters, planted with high-stem submerged plants 17 such as reeds and Vallisneria natans. The flourishing plants can slow down the flow rate and promote the sedimentation of the culturing sewage particles and the water quality purification of the photosynthetic bacteria. The water-quality biological purification area is an aquatic-alga-bacterium symbiotic system with a shallow water of 1.0 to 2.5 meters, planted with submerged floras 3 such as Vallisneria natans, and regularly applied with photosynthetic bacteria and beneficial algae fluids that are sprayed 1 to 6 times in every month to promote the diversified balanced development of aquatic-bacterium and three-dimensional water-quality purification. In the aquatic-bacterium symbiotic system, the aquatic plants 3 are submerged plants comprising reeds, Vallisneria natans, Myriophyllum verticillatum, Ceratophyllum demersum, Crispus and Hydrilla. The photosynthetic bacteria applied in the photosynthetic bacterium application area comprise a photoheterotrophic bacterium and a photoautotrophic bacterium.

The dark area 12 is an intensive culture pond, the top layer of which is covered by the sun cloth or sun shield to shield the sunshine and form the dimly-lit area, i.e., the dark area 12. Generally speaking, the illumination intensity of the water surface layer is 100 to 400 1×, which is suitable for culturing shads. The illumination requirements of the shads vary with the developmental stages, and the larvae love illumination more than the luce. Our growth tests show that the larvae of the shads with a weight of 20 to 80 g glow faster under the illumination of 800 1× than that under the illumination of 200 1×. However, under the illumination condition of 800 1×, the mortality (42.5%) of the shad (200 to 500 g) is significantly higher than the mortality under the illumination condition of 200 1× (8.6%), which is due to the premature maturation of a strong light-induced gonadal development, and a three-month intensive rear-end collision in spring that result in the death of the shad by injury. Therefore, the illumination intensity for culturing shads shall be regulated according to the individual development stages of the shads, and the illumination shall be especially for the shads (200 to 500 g) in the spring to avoid direct sunlight. The key to improve the survival rate for culturing the shad is to regulate different illumination intensities in the dark area by different shading methods and shading area, and to meet the different needs and adaptabilities of the different development stages of the shads to the dark light. Generally speaking, it is suitable for culturing shads when the illumination intensity of the water surface layer is 100 to 400 1×.

Due to the physiological characteristics of migration to the ocean of the shad, it mainly obtains oxygen through punching caused by fast swimming to promote the exchange of dissolved oxygen. Therefore, the dissolved oxygen is the most critical ecological factor in shad culturing, and swimming is a necessary behavior for the shads to obtain the dissolved oxygen. A large-area aquaculture water body meets the behavior of shad swimming in a large area and is of great significance for obtaining oxygen. A suitable aquaculture area is 50 to 400 m², and a suitable stocking density is 5 to 20 fishes/m².

In the intensive aquaculture area 20 of the dark area 12, the water depth is 1.0 to 3.0 meters, and a peddle-wheel aerator or a nano-tube aerator is used for oxygen aeration, so as to meet the dissolved oxygen supply for the shads. Taking the peddle-wheel aerator 10 as an example, several peddle-wheel aerators are installed in the intensive aquaculture area according to the aquaculture density or organic load to increase oxygen stir the water body and form a directional water flow 21 in the aquaculture area. The water body is agitated to flow in an opposite direction to the shad school at the same time of oxygenation, which conforms to the habit of the shads to obtain oxygen by moving and promotes water exchange in the water body. The shads are fed 3 to 6 times a day and for 10 to 20 min in each time. The dissolved oxygen and the temperature are measured regularly to ensure that the dissolved oxygen is maintained above 5 ppm. The water temperature is regulated through the deep well water flowing into the culture pond from a deep well water pipe, and the temperature is controlled within 18 to 30° C., so as to avoid the injury of a stress reaction to the shads caused by too low or too high temperature.

In the probiotic application area 9 of the intensive aquaculture area, probiotic preparations are regularly applied to enhance the water-quality purification capacity of the water body. For example, probiotics including Bacillus, nitrifying bacteria and lactic acid bacteria are mainly sprayed 1 to 6 times in every month to establish a healthy and active microbial community with purified water-quality.

Our production scale researches have shown that the dark-bright integrated greenhouse system in intensive recirculating eco-aquaculture according to the present invention is very suitable for the shads. The water-quality purification system in the bright area is relatively stable (the ammonia nitrogen is 0.2 to 0.8 ppm, the dissolved oxygen is no less than 5 ppm, and the temperature is 16 to 28° C.). In the dark area (the illumination is 300 to 600 1×), 78% of shad larvae (6 g) grow to 600 g (standard for sale) in 10 months, and the survival rate is as high as 92.4%. As a comparison, a standard factory-based recirculating aquaculture system is adopted; although the water-quality conditions are more stable, only 36% of shad larvae (6 g) grow to 600 g (standard for sale) in 10 months, and the survival rate is as 83.7%. The production efficiency is remarkably lower than that of the dark-bright integrated greenhouse system in intensive recirculating eco-aquaculture according to the present invention. We believe that the ammonia nitrogen is less than 0.8 ppm under the factory-based culturing condition, but the nitrate is higher than 2.6 ppm sometimes due to excessive nitrate enrichment caused by denitrification function deficiency; therefore, the toxicity of NH₃ is improved with the increase of pH value. Anyway, the artificial operation and the unstable culturing environment under the factory-based culturing condition induce a stress reaction which inhibits the growth of the shads. Obviously, the eco-aquaculture environment of the dark-bright integrated greenhouse is excellent, the eco-aquaculture water-quality purification effect is remarkable, the dark-bright integrated greenhouse system in intensive recirculating eco-aquaculture is highly successful in culturing shads, and will become the key to the sustainable development of the precious culture industry such as shads.

### Second Embodiment: Culturing of Penaeus vannamei in Dark-Bright Integrated Greenhouse

The dark-bright integrated greenhouse system of the embodiment is the same as that of the first embodiment.

Penaeus vannamei is euryhaline, and is a nocturnal animal, which loves a warm environment and is afraid of light, and is suitable to grown in a temperature ranging from 18 to 36° C. Therefore, it is necessary to keep warm in winter and prevent sunstroke in summer. To ensure the survival rate, the Penaeus vannamei must be cultivated in a dark greenhouse, and provided with water with good quality and adequate dissolved oxygen throughout the culturing.

1) Larvae stocking: before the shrimp seed stocking, and after clearing the pond for a week, the water depth is regulated to a range from 1.2 to 1.8 m. The recirculating pump in the bright area 2 of the greenhouse is opened to start the recirculating water in the bright area 2 and the dark area 12, wherein the water body exchange capacity is less, which is 0.1 to 0.5 times/hour. The fixed block-net 19 of the first partition 6 has 10 to 30 meshes.

In the dark area 12, the illumination intensity is controlled within a range from 50 to 300 1×. Floating artificial fiber aquatics are placed to expand the habitats of the shrimps. The stocking density of the larvae is 40 to 100/m3 and the specification of the larvae is about 0.8 to 1.2 cm.

2) Water-quality management: the Penaeus vannamei is extremely demanding on the water-quality. A suitable water temperature for growth is 22 to 32° C., a pH value is 7.2 to 8.5, dissolved oxygen is more than 4 mg/L, ammoniacal nitrogen is less than 0.2 mg/L, nitrite is less than 0.1 mg/L, and a transparency ranges from 30 to 40 cm. In the early stage of aquaculture, the water body exchange capacity was small. With the growth of the shrimp seeds, the water body exchange capacity is gradually increased by 20 to 40% every month. Water-quality monitoring is carried out regularly in the culturing process every week, temperature and dissolved oxygen are measured in the morning and evening of each day, ecological indexes of water-quality such as ammonia nitrogen and nitrite are measured every week, and management measures are regulated in time according to relevant measurements to ensure the culturing environment is within an appropriate range.

3) Water-quality purification management in the bright area: because the Penaeus vannamei has higher requirements on water-quality indexes and is extremely sensitive to environmental changes, the water-quality stability is extremely important. Although the water purification stability of the aquatic-photosynthetic bacterium symbiosis system is strong, it is easy to be affected by weather. Therefore, probiotics preparations should be added in time to avoid the change of water-quality in continuous rainy days.

4) Daily feeding and management: the Penaeus vannamei are fed for 4 to 8 times every day, the feeding amount is mainly based on the growth status of the larvae, the temperature and the water-quality, and an eight full principle is adopted to avoid overfeeding and destroying the water-quality. Attention shall be paid to the ingestion situation and larva activities to timely adjust the feeding amount and water-quality management measures.

5) Disease and insect control: the Penaeus vannamei have strong disease resistance and is not easy to get ill generally, but it is very difficult to treat once it is ill. Therefore, prevention should be prevailing. The most critical preventive measure is to strictly control the quality of the larvae and the water-quality management. Due to the relatively small water body exchange capacity, the application of microecological preparations in the dark area every week becomes the key to the water-quality management for Penaeus vannamei culturing, and the main microecological preparation is Bacillus.

6) Growth and survival rate: The system of the present invention shows great advantages in the culturing of the Penaeus vannamei, and is suitable for the growth environment of the Penaeus vannamei in dark environment and micro-water flow. The most important is that the ecological environment for culturing is excellent and stable, and is not affected by the external environment. In addition, in the dark environment of the present invention, the Penaeus vannamei no longer eats at night or in the morning and evening, but eats all day long. The daily ingestion time is prolonged, so that the growth advantage is manifested. After a four-month growing period, a specification of 20 to 40 Penaeus vannamei per 500 g is achieved, and the survival rate is 82 to 94%. Compared with the traditional culturing method, the harvesting date is advanced by about 20 days and the survival rate is higher by 20 to 30%; in addition, the Penaeus vannamei have no earthy smell, the taste and meat quality thereof are closer to those of wild Penaeus vannamei, and have better market evaluation and promotion values.

The above-mentioned embodiments should be understood as merely illustrative of the present invention and are not intended to limit the scope of protection of the present invention. After reading the contents recorded in the present invention, those skilled in the art can make various changes or modifications to the present invention, and these equivalent changes and modifications also fall within the scope of the present invention as defined in the claims.

What is claimed is:

1. A dark-bright integrated greenhouse system in intensive recirculating eco-aquaculture, comprising a greenhouse, wherein the greenhouse comprises a pond and a sunlight board covering above the pond, the pond is separated into a bright area and a dark area by a first partition, a sun shield or a sun cloth is covered on the sunlight board right above the dark area, the first partition is provided with a fixed block-net and a pump outlet, the pump outlet is connected with a pump, the pump is located in a pump cage; the bright area is separated into a first water treatment area and a second water treatment area by a second partition, the first water treatment area is provided with a primary sedimentation purification area and a water-quality biological purification area, the second water treatment area is also provided with a water-quality biological purification area, and the water-quality biological purification area is provided with a submerged flora planting area and a photosynthetic bacterium application area; and the dark area is provided with a probiotics application area and a plurality of aerators.

2. The dark-bright integrated greenhouse system in intensive recirculating eco-aquaculture according to claim 1, wherein the pump is a low-heading pump or a water-pushing aeration pump to pump purified water of the bright area into the dark area, and a daily water-body exchange frequency between the dark area and the bright area is 0.1 to 5 times per hour.

3. The dark-bright integrated greenhouse system in intensive recirculating eco-aquaculture according to claim 1, wherein submerged plants are planted in the primary sedimentation purification area, comprising one or more of Vallisneria natans, Ceratophyllum demersum, Hydrilla varticillata and Myriophyllum verticillatum.

4. The dark-bright integrated greenhouse system in intensive recirculating eco-aquaculture according to claim 1, wherein photosynthetic bacteria applied in the photosynthetic bacterium application area comprise a photoheterotrophic bacterium and a photoautotrophic bacterium.

5. The dark-bright integrated greenhouse system in intensive recirculating eco-aquaculture according to claim 1, wherein the dark area comprises an aquaculture area for culturing fishes, shrimps or crabs.

6. An application of the dark-bright integrated greenhouse system in intensive recirculating eco-aquaculture according to claims 1 in aquaculture.

7. An aquaculture method of a dark-bright integrated greenhouse system in intensive recirculating eco-aquaculture based on the system according to claim 1, wherein the aquaculture method regulates different illumination intensities of the dark area using different shading methods and shading areas to meet different requirements and adaptabilities of different aquaculture species and different growth stages to dark light.

8. The aquaculture method according to claim 7, wherein when the aquaculture specie is Alosa sapidissima, the illumination intensity is 100 to 400 1×, when the aquaculture specie is Perca flavescens, the illumination intensity is 50 to 150 1×, when the aquaculture specie is Siniperca chuatsi, the illumination intensity is 150 to 400 1×, when the aquaculture specie is Eriocheir sinensis, the illumination intensity is 50 to 100 1×, and when the aquaculture specie is Penaeus vannamei, the illumination intensity is 50 to 300 1×.

9. The aquaculture method according to claim 7, wherein when culturing shad, ammonia nitrogen is 0.2 to 0.8 ppm, dissolved oxygen is no lower than 5 ppm, and a temperature is 16 to 28° C.

10. The aquaculture method according to claim 7, wherein when feeding Penaeus vannamei, a water temperature is 22 to 32° C., a pH value is 7.2 to 8.5, dissolved oxygen is more than 4 mg/L, ammonia nitrogen is less than 0.2 mg/L, and nitrite is less than 0.1 mg/L.
